(19) United States
(12) Patent Application Publication
(10) Pub. No.: US 2021/0177186 A1
(43) Pub. Date: Jun. 17, 2021

(54) COOKTOP MODULE FOR CONNECTING TO A KITCHEN APPLIANCE BASE AS WELL AS COOKING SYSTEM

(71) Applicant: VORWERK & CO. INTERHOLDING GMBH, WUPPERTAL (DE)

(72) Inventor: CHRISTIAN BAYARD, WITTEN (DE)

(73) Assignee: VORWERK & CO. INTERHOLDING GMBH, WUPPERTAL (DE)

(21) Appl. No.: 17/109,991

(22) Filed: Dec. 2, 2020

(30) Foreign Application Priority Data
Dec. 12, 2019 (DE) 10 2019 134 095.0

(51) Int. Cl. A47J 27/00; A47J 36/32; A47J 43/046

(52) U.S. Cl. CPC A47J 27/004; H05B 3/68; A47J 43/046; A47J 36/32

(57) ABSTRACT

A cooktop module (1) to connect to a kitchen appliance base (2). The range of functions of kitchen appliances is expanded, in that the cooktop module (1) features at least one surface (3) for at least one cooking vessel (9), at least one electrical heating means (4), at least one connection area (5) for accommodation on the kitchen appliance base (2), and at least one electrical contact means (6), wherein a cooking vessel (9) which can be positioned on the surface (3) can be warmed by the heating means (4), and wherein the heating means (4) can be electrically connected to the kitchen appliance base (2) via the electrical contact means (6).

### CROSS-REFERENCE TO RELATED APPLICATIONS

This application claims the benefit of priority under 35 U.S.C. § 119 to German Patent Application No. 10 2019 134 095.0, filed Dec. 12, 2019, the contents of which are incorporated herein by reference in their entirety.

### FIELD OF THE INVENTION

The invention relates to a cooktop module for connecting to a kitchen appliance base. Furthermore, the invention relates to a cooking system which comprises at least one kitchen appliance base and at least one cooktop module.

### BACKGROUND

Mobile cooktops are known from the prior art which can be provided with voltage via a power connector, and feature a surface for at least one cooking vessel. These devices can only be used for this purpose.

Furthermore, kitchen appliances are known from the prior art which feature, for example, an accommodating area for a preparation vessel. The preparation vessel has at least one heating means as well as electrical contact means for connecting of the heating element to the kitchen appliance base. Furthermore, mechanical interfaces are present which transfer rotational momentum from the kitchen appliance base to a stirring and chopping unit disposed in the preparation vessel. A control unit of the kitchen appliance at least partially automatically controls, for example, a preparation process of food.

Admittedly, the kitchen appliances known from the prior art feature the disadvantage that food can only be prepared using the preparation vessel provided therefor.

Therefore, the task of the invention is to expand the range of functions of kitchen appliances.

The aforementioned task is accomplished with a cooktop module according to embodiment of the invention described herein. The cooktop module features at least one surface for at least one cooking vessel. At least one cooking vessel can be positioned on the surface, so that the cooking vessel - if applicable, with food disposed therein - can be heated via the electrical heating means which is disposed below or within the surface. The surface is preferably designed at least partially of glass and/or glass ceramic.

SUMMARY AND INTRODUCTORY DESCRIPTION OF EMBODIMENTS OF THE INVENTION

The cooktop module according to the invention is designed to be connectable to a kitchen appliance base. The kitchen appliance base preferably features a housing with at least one receiving area, in particular for receiving a preparation vessel, at least one electric motor, at least one weighing unit, in particular in the receiving area, and a power supply. It is preferable that at least one opposing contact means is provided in the receiving area of the kitchen appliance base for creating an electrical connection to the contact means of the cooktop module, or rather, to the contact means of a preparation vessel.

Furthermore, it is preferable that in the receiving area at least one drive interface is provided for transferring rotational movement generated by the electric motor. This drive interface is used during operation with a preparation vessel for the purpose of driving a stirring and chopping unit. Additionally, the kitchen appliance base features in particular a control unit, with which in particular the electric motor and the opposing electrical contact means can be controlled. The control unit preferably comprises a power electronics unit for operating at least one heating means connected to the opposing contact means.

The electrical heating means of the cooktop module is electrically connected to the kitchen appliance base, in particular the power supply of the kitchen appliance base, via the electrical contact means when the cooktop module is inserted into a receiving area of the kitchen appliance base with its connection area. The heating means of the cooktop module is provided with voltage via the electrical contact means. The electrical contact means is preferably disposed such that it automatically makes contact with the opposing contact means of the kitchen appliance base when the cooktop module is inserted into the receiving area of the kitchen appliance base with its connection area. The cooktop module can thus be inserted into the receiving area of the kitchen appliance base and can also be removed therefrom. The connection area is preferably designed such that it can be inserted into the receiving area of the kitchen appliance base which is also provided for receiving a preparation vessel. The connection area can in particular be inserted into the receiving area in a positive locking manner.

The opposing electrical contact means can be controlled via the control unit of the kitchen appliance base, so that at least the heating means of the cooktop module can be controlled via the control unit of the kitchen appliance base. In particular, the heating means of the cooktop module is thus controllable via the operating elements of the kitchen appliance base.

The electrical contact means of the cooktop module features, for example, at least three prongs, which are inserted into the opposing contact means of the kitchen appliance base, which are designed as corresponding contact sockets, in order to create an electrical connection. The invention also provides that the contact means are designed as contact surfaces, arched spring elements, or contact rings.

In contrast to the prior art, the invention features the advantage that the range of applications of the kitchen appliance base is expanded, as cooking vessels of varying size and type can be used on the kitchen appliance base with the cooktop module. The cooktop module requires no control system and power electronics unit of its own, but rather uses the existing components of the kitchen appliance base, in that the electrical contact means are connected to the opposing contact means of the kitchen appliance base.

In order to be able to favorably control the heat output of the heating means, the invention provides that in a first embodiment of the cooktop module, at least one sensor, in particular at least one temperature sensor, such as a thermocouple, is present. For example, a plurality of sensors, in particular temperature sensors, is provided. The temperature sensor is preferably arranged for measurement of the surface temperature of the surface. Thus the surface temperature of the surface is monitored with the temperature sensor and the heat output of the heating means can be adjusted corresponding to a desired target temperature.

For a favorable adjustment of the heat output, it has proven favorable in a further embodiment of the cooktop module that the cooktop module features at least one signal interface for transmitting electrical signals to an opposing signal interface of the kitchen appliance base. The opposing signal interface is in particular connected to the control unit of the kitchen appliance base.

The signal interface preferably transmits, for example, the measurement signals of the at least one temperature sensor, preferably a plurality of temperature sensors, to the kitchen appliance base, in particular to the control unit of the kitchen appliance base. The signal interface is preferably designed identically to the electrical contact means, so that the electrical contact means features, for example, three contact prongs and the signal interface features two additional—identically designed—contact prongs, in order to transmit electrical signals to the kitchen appliance base. The signal interface is preferably designed and configured for transmission of data.

For example, the temperature of the surface is transmitted to the control unit of the kitchen appliance base via the signal interface and the control unit regulates the heat output of the heating means of the cooktop module via the electrical contact means, based on a target temperature which can be set by the user.

For example, in order to realize a stirring function within a cooking vessel, according to a further embodiment of the cooktop module, the invention provides that the cooktop module features at least one coupling for transferring rotational momentum, in particular at least one magnetic coupling. The coupling is preferably disposed within or underneath the surface. In particular, the coupling features at least one rotatably-mounted magnet. Then a corresponding magnet with at least one stirring blade can then be disposed inside a cooking vessel. The rotation of the rotatably-mounted magnet moves the magnet disposed in the cooking vessel along with it and the stirring blade rotates, for example, to prevent burning of food in the cooking vessel.

The invention provides that the coupling, in particular the magnetic coupling, is driven by at least one motor which is disposed within the cooktop module. The motor is, for example, provided with voltage via the electrical contact means and/or is controllable via the signal interface, in particular by the control unit of the kitchen appliance base. The invention also provides that the coupling can be driven into rotational movement by the electric motor of the kitchen appliance base, via the drive interface of the kitchen appliance base.

According to a further embodiment, it has proven favorable that the heating means features at least one electric radiant heating means, in particular a ceramic insulated heating element, and/or at least one induction heating means, and/or at least one thick film heating means. The heating means is especially preferably designed as an induction heating means and disposed underneath or in the surface. In this way, cooking vessels intended for induction heating means can be disposed on the surface and warmed by the heating means.

A further embodiment of the cooktop module provides that the heating means features at least two heating zones in the surface, and that the heating zones can be separately controlled. The two heating zones favorably feature separate electrical contact means, in order to be separately controllable by a control unit of the kitchen appliance base. The heating zones are located in the surface for at least a single cooking vessel or the two heating zones are disposed next to one another, so that two separate cooking vessels can be warmed with the different heating zones of the heating means independently of one another.

According to a further embodiment of the cooktop module, it is particularly preferable that the surface is designed as completely flat. A typical cooking pot can be disposed on a completely flat surface and can be warmed with the heating means. Furthermore, the invention provides that the surface is designed as at least partially convex. A partially convex surface features the advantage that a cooking vessel corresponding to the shape of the surface can be disposed on the convex surface and held in a positive locking manner on the surface without, for example, sliding sideways. Furthermore, the invention provides, for example, that the surface features a convex domed ring, which prevents sideways slippage of a cooking vessel from the otherwise flat surface.

A further development provides that the surface is designed as at least partially concave. A concave surface is particularly favorable when using a wok as a cooking vessel. The shape of the wok fits into the concave domed surface. Alternatively or additionally, the invention provides that the surface features a plurality of flexible ring faces or a plurality of flexibly-positioned ring faces. Due to the flexible ring faces, or rather, the flexibly-positioned ring faces, the surface automatically adapts to the shape of the cooking vessel. If a completely flat cooking vessel is used, the ring faces do not deform. If, for example, a wok is used, the flexible ring faces or the flexibly-positioned ring faces adapt to the shape of the underside of the cooking vessel.

To fasten the cooktop module to the kitchen appliance base, according to a further embodiment, the invention preferably provides that at least one retaining area, preferably two retaining areas, are provided for the kitchen appliance base, to operate in conjunction with at least one retaining arm, preferably with two retaining arms. In particular, the kitchen appliance base features two retaining arms, each respectively rotatable around its own longitudinal axis. Through the rotation around their longitudinal axes, the retaining arms can be swung between a release position and a locking position. In the locking position, the retaining arms engage in the retaining areas of the cooktop module in a positive locking manner such that the cooktop module cannot be removed from the kitchen appliance base. In this way it is ensured that the cooktop module, in particular the connection area, cannot disengage from the receiving area of the kitchen appliance base during use.

The initially specified task is additionally solved by a cooking system which features a kitchen appliance base with at least one receiving area, at least one control unit, and at least one power supply as well as a cooktop module according to one of the previous exemplary embodiments. The kitchen appliance base is, for example, designed as previously described. The cooktop module can be disposed, or rather, is disposed with its connection area in the receiving area of the kitchen appliance base.

When the cooktop module is disposed with its connection area in the receiving area, then the electrical contact means as well as the signal interface of the cooktop module are also preferably automatically connected to corresponding opposing contact means or opposing signal interfaces of the kitchen appliance base. In this way, the cooktop module can be operated via an operating unit of the kitchen appliance base. The kitchen appliance base features two retaining arms which can be rotated around their longitudinal axes, which—as previously described—can affix the cooktop module onto the kitchen appliance base.

### BRIEF DESCRIPTION OF THE DRAWINGS

Additional favorable embodiments of the invention are indicated in the following figure description and the dependent subordinate claims. Shown here:

FIG. 1 shows an exemplary embodiment of a cooktop module in a partially cut-away view,

FIG. 2 shows an exemplary embodiment of a cooking system in a perspective view,

FIG. 3 shows an additional exemplary embodiment of a cooking system in a perspective view, and

FIGS. 4a-4c show exemplary embodiments of cooktop modules in partially cut-away views.

### DETAILED DESCRIPTION

The same components are always denoted by the same reference numerals in the various figures.

For the following description it is to be noted that the invention is not restricted to the exemplary embodiments and therefore not to all or multiple features of the described feature combinations; furthermore, every individual partial feature of each and every design example is also meaningful for the object of the invention separately from all other partial features described in combination, and also in combination with any features of another exemplary embodiment.

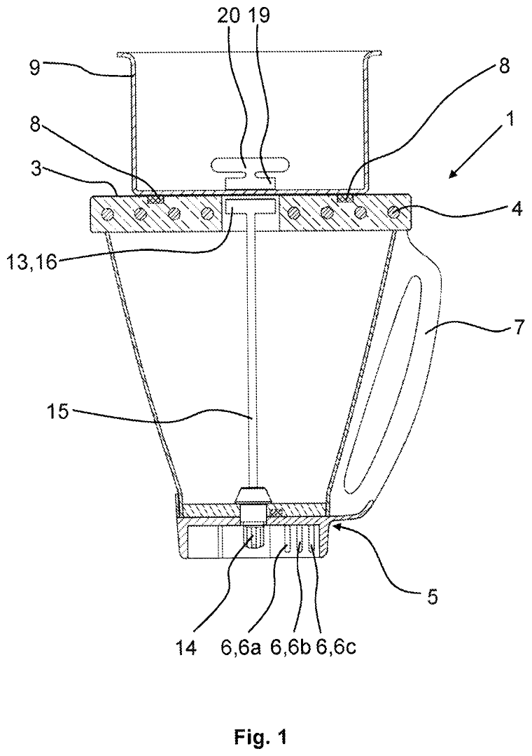

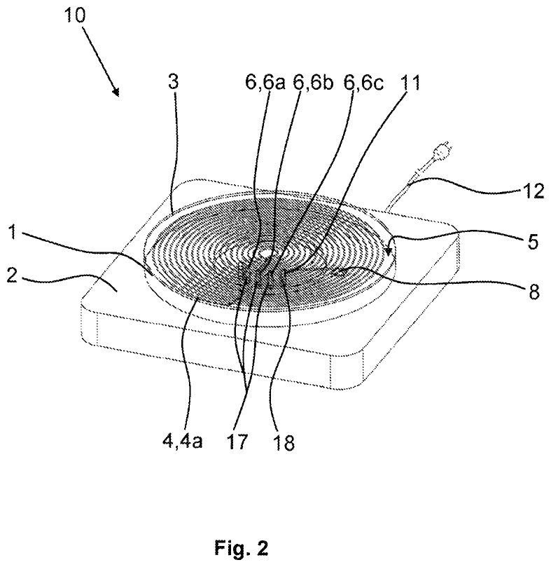

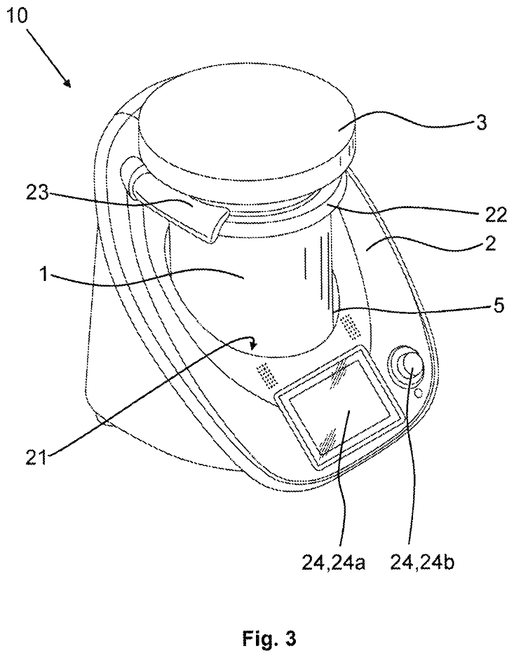

FIG. 1 depicts an exemplary embodiment of a cooktop module 1 in at least partially cut-away side view. The cooktop module 1 is intended to be connected to a kitchen appliance base 2—shown as an example in FIG. 2 and FIG. 3. The cooktop module 1 features a surface 3 for at least one cooking vessel 9, which is designed as a cooking pot here. In the exemplary embodiment of FIG. 1, the surface 3 is completely flat and at least partially made of a glass ceramic. Underneath the surface 3, an electrical heating means 4 is disposed, which is designed as an induction heating means in this exemplary embodiment.

The cooktop module 1 features a connection area 5 for connecting the cooktop module 1 to a kitchen appliance base 2. The electrical contact means 6 is disposed in the connection area 5 in the form of three contact prongs 6a, 6b, 6c. When the cooktop module 1 is placed with its connection area 5 into a kitchen appliance base 2, then the electrical contact means 6 automatically make contact with an opposing contact means 17—depicted in FIG. 2—of the kitchen appliance base 2. The heating means 4 makes electrical contact and is provided with voltage via the electrical contact means 6. For easy operation, the cooktop module 1 features a hand grip 7 which facilitates the cooktop module 1 being inserted into or removed from the kitchen appliance base 2.

According to FIG. 1, two sensors 8 are disposed in the surface 3, which are designed as thermocouples in this exemplary embodiment. The surface temperature of the surface 3 can be determined by the sensors 8. The measurement signals of the sensors 8 can be transmitted via a signal interface 11—depicted as an example in FIG. 2—via an opposing signal interface of the kitchen appliance base 2—to a control unit of the kitchen appliance base 2. The control unit regulates, for example, the heat output of the heating means 4, in order to reach a predetermined surface temperature for the cooking vessel 9 positioned on the surface 3.

FIG. 2 depicts an exemplary embodiment of a cooktop module 1 with a kitchen appliance base 2 which together form a cooking system 10. For an easier understanding of the construction, the cooktop module 1 is depicted at least partially transparently. The cooktop module 1 is connected to the kitchen appliance base 2 with the connection area 5. The heating means 4, which in this exemplary embodiment features one heating zone 4a, is disposed underneath the surface 3 for at least one cooking vessel 9. The heating means 4 is electrically connected to the kitchen appliance base 2 via the electrical contact means 6, via the opposing contact means 17. The opposing contact means 17 is connected to the control unit, including the power electronics unit, of the kitchen appliance base 2.

Additionally, the cooktop module 1 features a sensor 8, designed as a temperature sensor, underneath the surface 3, which makes contact via a signal interface 11 with an opposing signal interface 18 of the kitchen appliance base 2. The measurement signals of the sensor 8 are thereby transmitted to the control unit of the kitchen appliance base 2. In this exemplary embodiment the kitchen appliance base 2 features a power supply 12 in the form of an electrical connecting plug.

In the exemplary embodiment of FIG. 1, the cooktop module 1 features a coupling 13, designed as a magnetic coupling, for transferring of rotational momentum. In this exemplary embodiment the coupling 13 comprises a mechanical interface 14, which can be coupled in a positive locking manner to a drive interface—not depicted—of the kitchen appliance base 2. The rotation of an electric motor of the kitchen appliance base 2 can be transferred to a coupling member 15 via the mechanical interface 14. A magnetic head 16 is disposed on the coupling member 15, in which a rotational movement can be induced via the coupling member 15. An opposing magnet 19 can be disposed in a cooking vessel 9, which is coupled to a stirring blade 20, in order to, for example, prevent stirring of a liquid food item disposed in the cooking vessel 9. FIG. 3 depicts a further exemplary embodiment of a cooktop module 1 in a kitchen appliance base 2, which together form a cooking system 10. The cooktop module 1 is installed by its connection area 5 into a corresponding receiving area 21 of the kitchen appliance base 2. In this exemplary embodiment a circumferential collar is designed as a retaining area 22 underneath the surface 3. The retaining area 22 works together with two rotatable and oppositely disposed retaining arms 23—only one retaining arm visible in FIG. 3—of the kitchen appliance base 2. The retaining arms 23 can be swung around their longitudinal axes between a locking position—depicted in FIG. 3—and a release position—not depicted. In the depicted locking position of the retaining arms 23, the cooktop module 1 cannot be removed from the kitchen appliance base 2.

Due to the fact that the cooktop module 1 also makes electrical contact with the kitchen appliance base 2, all functions of the cooktop module 1 can be controlled via the operating unit 24, in particular the touch display 24a and the rotary switch 24b, of the kitchen appliance base 2.

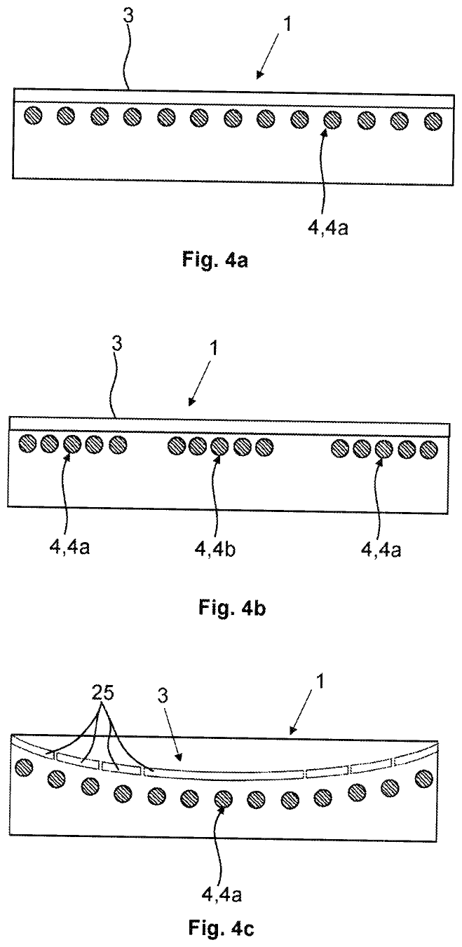

FIG. 4a to FIG. 4c depict exemplary embodiments of cooktop modules 1 in partially cut-away side views.

According to FIG. 4a, the heating means 4 features a single heating zone 4a. The surface 3 is designed as completely flat.

In the exemplary embodiment of FIG. 4b, the surface 3 is also designed as flat. The heating means 4 features two separately controllable heating zones 4a, 4b.

In the exemplary embodiment of FIG. 4c, the surface 3 is designed as concave and features a plurality of flexible ring faces 25. An exemplary embodiment of a cooktop module 1 such as this is favorably usable with a wok. The heating means 4 features only one heating zone 4a.

The invention is not limited to the depicted and described design examples, but rather encompasses all designs of equivalent function in the sense of the invention. It is explicitly noted that the exemplary embodiments are not limited to all individual features in combination, but rather each individual feature can be meaningful to the invention independently of all other individual features. Furthermore, the invention has hitherto not been restricted to the combination of features as described in claim 1, but rather can also be defined by any other desired combination of features out of all of the features described in total. This means that in essence practically every individual feature of claim 1 can be omitted or replaced by at least one other feature described elsewhere in this application.

While the above description constitutes the preferred embodiment of the present invention, it will be appreciated that the invention is susceptible to modification, variation and change without departing from the proper scope and fair meaning of the

[symbol]

1. A cooktop module adapted for connecting to a kitchen appliance base, comprising at least one surface for at least one cooking vessel, at least one electrical heating means, at least one connection area for accommodation on the kitchen appliance base, and at least one electrical contact means, wherein a cooking vessel which can be positioned on the surface can be warmed by the heating means, and wherein the heating means can be electrically connected to the kitchen appliance base via the electrical contact means.

2. The cooktop module according to claim 1, wherein at least one sensor is provided.

3. The cooktop module according to claim 1, wherein at least one signal interface is provided for transmission of electrical signals to an opposing signal interface of the kitchen appliance base.

4. The cooktop module according to claim 1, wherein at least one coupling is provided for transferring of rotational movement.

5. The cooktop module according to claim 1, wherein the heating means features at least one electrical radiant heating means.

6. The cooktop module according to claim 1, wherein the heating means features at least two heating zones in the surface, and that the heating zones can be separately controlled.

7. The cooktop module according to claim 1, wherein the surface is designed as completely flat or at least partially convex or at least partially concave.

8. The cooktop module according to claim 1, wherein at least one retaining area, is provided to function together with at least one retaining arm of the kitchen appliance base.

9. The cooking system, comprising at least one kitchen appliance base, wherein the kitchen appliance base features at least one receiving area, at least one control unit, and at least one power supply, having the cooktop module according to claim 1, that the cooktop module can be disposed with its connection area in the receiving area of the kitchen appliance base.

10. The cooking system according to claim 9, wherein the electrical contact means of the cooktop module can make contact with opposing electrical contact means of the kitchen appliance base for voltage supply to the heating means.

11. The cooking system according to claim 9, wherein the kitchen appliance base features two retaining arms, and that the retaining arms can function together with at least one retaining area on the cooktop module in order to secure the cooktop module in the receiving area.

12. The cooktop module according to claim 2, wherein the sensor is a temperature sensor.

13. The cooktop module according to claim 12, wherein the temperature sensor is arranged for measurement of the surface temperature of the surface.

14. The cooktop module according to claim 3, wherein the signal interface is connected to at least one sensor.

15. The cooktop module according to claim 4, wherein the at least one coupling a magnetic coupling.

16. The cooktop module according to claim 5, wherein the heating means features at least one of a ceramic insulated heating element, at least one induction heating means or at least one thick film heating means.

17. The cooktop module according to claim 1, wherein the surface features a plurality of flexible ring faces or a plurality of flexibly-positioned ring faces.

18. The cooktop module according to claim 1, wherein at least two retaining areas are provided to function together with at least two retaining arms of the kitchen appliance base.

19. The cooking system according to claim 11, wherein the two retaining arms are rotatable.

20. The cooking system according to claim 11, wherein the retaining arms can function together with at least two retaining areas.
